(19) United States
(12) Patent Application Publication
(10) Pub. No.: US 2024/0276979 A1
(43) Pub. Date: Aug. 22, 2024

(54) CRYSTAL GROWTH INHIBITORS FOR AGRICULTURAL FORMULATIONS

(71) Applicant: Stepan Company, Northbrook, IL (US)

(72) Inventors: Mathieu PEPIN, Coublevie (FR); Laure CANAL, Grenoble (FR); Elodie SHAW, Fontaine (FR); Pierre GIGAND, Meylan (FR); Sandrine MONTHEIL, Grenoble (FR); Michèle CHEVRIER, Grenoble (FR)

(21) Appl. No.: 18/560,993

(22) PCT Filed: Aug. 25, 2022
(86) PCT No.: PCT/US2022/041448

§ 371 Date: Nov. 15, 2023

Related U.S. Application Data
(60) Provisional application No. 63/237,582, filed on Aug. 27, 2021.

(51) Int. Cl. A01N 25/04; A01N 37/22; A01N 43/707; A01N 47/36; A01P 3/00; A01P 13/00

(52) U.S. Cl. CPC A01N 25/04; A01N 37/22; A01N 43/707; A01N 47/36; A01P 3/00; A01P 13/00

(57) ABSTRACT

Crystal growth inhibitor compositions useful for agricultural formulations are disclosed. The compositions comprise a comb copolymer dispersant and an alkyl-capped polyalkoxylate. The dispersants comprise recurring units of styrene, methacrylic acid, and a methacrylate ester of an alkyl-capped polyalkoxylate having a number average molecular weight within the range of 300 to 3,000 Da. The inhibitor compositions are effective for agricultural actives that tend to crystallize or form large aggregates upon storage for even a short time, including pesticides from the acylalanine, oxyacetamide, triazinone, sulfonylurea, strobilurin, halogenated pyrrole, neonicotinoid, triazole, and pyridine carboxamide families.

### FIELD OF THE INVENTION

The invention relates to compositions useful for inhibiting crystal growth in agricultural formulations.

### BACKGROUND OF THE INVENTION

Agricultural compositions, particularly aqueous formulations, are most useful when they can be stored for prolonged periods at a wide range of temperatures without settling or forming precipitates of the agricultural active. Some agricultural actives are prone to form large crystals or aggregates of crystals that can precipitate from aqueous media after even a relatively short time.

U.S. Publ. No. 2002/0040044, for instance, describes various surfactants having the ability to inhibit the crystal growth of certain triazole fungicides. The surfactants include tristyrylphenol ethoxylates and their sulfate derivatives, EO/PO block copolymers, and vinylpyrrolidone polymers.

Comb copolymers having an acrylic backbone and “teeth” formed from acrylic polyether macromonomers have been described for use in pigment dispersions (see, e.g., U.S. Pat. No. 6,582,510), water-reducing agents for cement (see, e.g., U.S. Pat. No. 6,214,958), and agricultural compositions (see, e.g., U.S. Pat. No. 5,139,773 and EP 0007731). More recently, copolymer dispersants made from acrylic acid, a hydrophobic monomer, alkylacrylates of monoalkyl polyethylene glycols, and optionally strong acid derivatives of (meth)acrylic acid have been described (see U.S. Publ. No. 2021/0029989).

The '989 publication describes formulations of imidacloprid or buprofezin that are combined with the comb copolymer dispersants to inhibit crystal growth. Despite the limited experimental demonstration, the list of purportedly suitable agricultural actives is relatively unlimited. The '989 publication recommends neutralizing acidic groups in the comb copolymer and does not suggest combining it with an alkyl-capped polyalkoxylate solvent.

Challenges remain in identifying compositions that effectively inhibit crystal growth in aqueous agricultural formulations. Ideally, the compositions would be effective across a range of classes of agricultural actives, particularly actives that tend to crystallize or form large aggregates upon storage for even a short time, including numerous popular pesticides from the acylalanine, oxyacetamide, triazinone, sulfonylurea, strobilurin, halogenated pyrrole, neonicotinoid, triazole, and pyridine carboxamide families.

### SUMMARY OF THE INVENTION

In one aspect, the invention relates to an inhibitor composition. The inhibitor composition comprises a comb copolymer dispersant and an alkyl-capped polyalkoxylate. The comb copolymer dispersant comprises recurring units of styrene, methacrylic acid, and a methacrylate ester of a first alkyl-capped polyalkoxylate, the first alkyl-capped polyalkoxylate having a number average molecular weight within the range of 300 to 3,000 Da. The inhibitor composition includes a second alkyl-capped polyalkoxylate having a number average molecular weight within the range of 300 to 3,000 Da. The inhibitor composition comprises 60 to 97 wt. % of this comb copolymer dispersant and 3 to 40 wt. % of the second alkyl-capped polyalkoxylate, wherein the weight percent amounts are based on the combined amounts of the two components. When combined at 0.1 to 5 wt. % with an agricultural active, the inhibitor compositions can inhibit crystal growth of the agricultural active. The degree of crystal growth inhibition is conveniently observed using readily available techniques, including optical microscopy and dynamic light scattering.

In another aspect, the invention includes agricultural compositions. The compositions comprise an agricultural active selected from acylalanines, oxyacetamides, triazinones, sulfonylureas, strobilurins, halogenated pyrroles, neonicotinoids, triazoles, and pyridine carboxamides and 0.1 to 5 wt. %, based on the amount of agricultural active, of the inhibitor compositions described above.

The invention includes a method which comprises combining an agricultural active selected from acylalanines, oxyacetamides, triazinones, sulfonylureas, strobilurins, halogenated pyrroles, neonicotinoids, triazoles, and pyridine carboxamides with an inhibitor composition as described above. The inhibitor composition is present in an amount effective to inhibit crystal growth of the agricultural active as determined by optical microscopy or dynamic light scattering.

The invention provides compositions that are straightforward to produce and effectively inhibit crystal growth in a wide range of agricultural compositions. Surprisingly, a combination of a comb copolymer dispersant and an alkyl-capped polyalkoxylate solvent is needed to impart good storage stability and sustained inhibition of crystal growth. The inhibitor compositions are effective for agricultural actives that tend to crystallize or form large aggregates upon storage for even a short time, including pesticides from the acylalanine, oxyacetamide, triazinone, sulfonylurea, strobilurin, halogenated pyrrole, neonicotinoid, triazole, and pyridine carboxamide families.

### BRIEF DESCRIPTION OF THE DRAWINGS

FIG. 1 shows particle size distribution (vol. % particles v. size in μm) as measured by dynamic light scattering (DLS) for metribuzin in water at Day 0, in water at Day 14, and in the presence of an inventive inhibitor composition (“dispersant”) at Day 14.

FIG. 2 shows particle size distribution as measured by DLS for metalaxyl in water at Day 0, in water at Day 7, and in the presence of an inventive inhibitor composition at Days 7 and 14.

FIG. 3 shows particle size distribution as measured by DLS for metsulfuron in water at Day 0, in water at Day 14, and in the presence of an inventive inhibitor composition at Day 14.

FIG. 4 shows particle size distribution as measured by DLS for nicosulfuron in water at Day 0, in water at Day 14, and in the presence of an inventive inhibitor composition at Day 14.

FIG. 5 illustrates the impact of using an inventive inhibitor composition when compared with a comb copolymer dispersant alone, mPEG750 solvent alone, or a comb copolymer dispersant with either PEG800 (same molecular weight as mPEG750) or PEG1500 (same hydroxyl number as mPEG750).

FIG. 6 shows optical microscopy images at the same scale of solutions of metalaxyl in water at Day 0, metalaxyl in water at Day 14, and metalaxyl plus an inventive inhibitor composition at Day 14.

FIG. 7 shows optical microscopy images at the same scale of solutions of nicosulfuron in water at Day 0, nicosulfuron in water at Day 14, and nicosulfuron plus an inventive inhibitor composition at Day 14.

### DETAILED DESCRIPTION OF THE INVENTION

In some aspects, the invention relates to inhibitor compositions for agricultural compositions. The inhibitor compositions comprise a comb copolymer dispersant and an alkyl-capped polyalkoxylate solvent.

### Comb Copolymer Dispersant

The inhibitor compositions include a comb copolymer dispersant. The dispersant comprises recurring units of styrene, methacrylic acid, and a methacrylate ester of a first alkyl-capped polyalkoxylate. The first alkyl-capped polyalkoxylate has a number average molecular weight (by GPC, polystyrene standards) within the range of 300 to 3,000 Da, or in some aspects, from 350 to 2,000 Da. The methacrylate ester is also referred to herein as a “macromonomer.”

In some aspects, the alkyl-capped polyalkoxylate is capped or terminated with a C₁-C₈ or a C₁-C₄ linear or branched alkyl group. In some aspects, the polyalkoxylate is capped with a methyl group or a butyl group, preferably a methyl group.

In some aspects, the polyalkoxylate portion of the alkyl-capped polyalkoxylate is an ethylene oxide (EO) homopolymer, a propylene oxide (PO) homopolymer, or a block or random copolymer of EO and PO. In a preferred aspect, the alkyl-capped polyalkoxylate is a monomethyl-terminated polyethylene glycol, commonly known as a “mPEG,” having a number-average molecular weight within the range of 300 to 3,000 Da.

The first alkyl-capped polyalkoxylate preferably has at least one free hydroxyl group, although a minor proportion of the product might be fully capped (e.g., as a dimethyl-terminated PEG). The latter portion, which is unavailable for incorporation into the macromonomer, would serve as some or all of the second alkyl-capped polyalkoxylate in that case.

In some aspects, the dispersant comprises 25 to 50 wt. %, or 30 to 50 wt. %, or 30 to 40 wt. % of styrene recurring units and 0.1 to 10 wt. %, or 1 to 8 wt. %, or 3 to 6 wt. % of methacrylic acid recurring units, and 45 to 75 wt. %, or 50 to 70 wt. %, or 55 to 65 wt. % of macromonomer recurring units based on the amount of comb copolymer dispersant.

The inhibitor composition, which includes a second alkyl-capped polyalkoxylate as a solvent, comprises 60 to 97 wt. % of the comb copolymer dispersant, based on the combined amounts of comb copolymer dispersant and second alkyl-capped polyalkoxylate. In some aspects, the inhibitor composition comprises 65 to 95 wt. %, or 70 to 90 wt. %, of the comb copolymer dispersant.

The comb copolymer dispersant can include recurring units of other ethylenic monomers such as vinyl monomers, (meth)acrylamides, (meth)acrylate esters, acrylic acid, vinyl sulfonic acids, or the like. In some aspects, the comb copolymer dispersant comprises 0.1 to 10 wt. %, based on the amount of comb copolymer dispersant, of monomers other than styrene, methacrylic acid, and the macromonomer. In other aspects, the comb copolymer dispersant consists of or consists essentially of recurring units of styrene, methacrylic acid, and the macromonomer.

The comb copolymer dispersant is conveniently made by combining the monomers in aqueous media in any desired order with a chain transfer agent (e.g., dodecanethiol), a free-radical initiator (e.g., an azo compound such as 2,2-azobis(2-methylpropionamide)dihydrochloride), the alkyl-capped polyalkoxylate solvent, and any auxiliary solvents (e.g., propylene glycol, glycerol, or the like). The ingredients are combined in the presence of enough heat to decompose the initiator (typically 40° C. to 120° C.), and polymerization continues to the desired degree of completion. An aqueous solution of the resulting inhibitor composition, because it has recurring units of methacrylic acid, will be acidic, with pH typically ranging from 4 to 7 or from 5 to 6. In some aspects, the comb copolymer dispersant will be unneutralized; in other aspects, partial neutralization of the acidic groups may be desirable.

In some aspects, the comb copolymer will have a number-average molecular weight (GPC) within the range of 10 kDa to 150 kDa, from 20 kDa to 90 kDa, or from 30 kDa to 60 kDa.

### Alkyl-Capped Polyalkoxylate Solvent

The inhibitor composition includes an alkyl-capped polyalkoxylate. To distinguish this component from the alkyl-capped polyalkoxylate used to make the macromonomer, the alkyl-capped polyalkoxylate solvent is also referred to herein as the “second” alkyl-capped polyalkoxylate. The second alkyl-capped polyalkoxylate has a number average molecular weight (by GPC, polystyrene standards) within the range of 300 to 3,000 Da, or in some aspects, from 500 to 2,000 Da.

In some aspects, the second alkyl-capped polyalkoxylate is capped (or terminated) with a C₁-C₈ or a C₁-C₄ linear or branched alkyl group. In some aspects, the second polyalkoxylate is capped with a methyl group or a butyl group, preferably a methyl group. Unlike the first alkyl-capped polyalkoxylate, the second alkyl-capped polyalkoxylate can be fully capped with alkyl groups.

In some aspects, the polyalkoxylate portion of the second alkyl-capped polyalkoxylate is an ethylene oxide (EO) homopolymer, a propylene oxide (PO) homopolymer, or a block or random copolymer of EO and PO. In a preferred aspect, the second alkyl-capped polyalkoxylate is a mPEG having a number-average molecular weight within the range of 300 to 3,000 Da.

The first and second alkyl-capped polyalkoxylate compositions can be the same or different from each other. Most conveniently, the first and second alkyl-capped polyalkoxylate compositions are monoalkyl-capped and identical such that enough of the alkyl-capped polyalkoxylate is used in making the comb copolymer dispersant that any unreacted alkyl-capped polyalkoxylate serves as the second alkyl-capped polyalkoxylate, i.e., as the solvent component of the inhibitor composition. For instance, in a preferred aspect, the first and second alkyl-capped polyalkoxylates are the same monomethyl-terminated PEG composition.

The inhibitor composition comprises 3 to 40 wt. % of the second alkyl-capped polyalkoxylate based on the combined amounts of the comb copolymer dispersant and second alkyl-capped polyalkoxylate. In some aspects, the inhibitor composition comprises 10 to 35 wt. %, or 20 to 30 wt. %, of the second alkyl-capped polyalkoxylate.

In some aspects, the inhibitor compositions include other components such as water, organic solvents (especially glycerol, propylene glycol, or the like), biocides, surfactants, wetting agents, antifoam agents, or combinations thereof. We found that choice of organic solvent can, at least in some cases, be used to control the molecular weight of the comb copolymer (see Example 1, below).

### Agricultural Compositions

The invention includes agricultural compositions comprising the inhibitor compositions described above and an agricultural active. In particular, the compositions comprise 0.1 to 5 wt. % of the inhibitor composition based on the combined amounts of agricultural active and inhibitor composition. In some aspects, the compositions comprise 0.2 to 3 wt. % or 0.5 to 3 wt. % of the inhibitor composition based on the combined amounts of agricultural active and inhibitor composition. The agricultural active is selected from acylalanines, oxyacetamides, triazinones, sulfonylureas, strobilurins, halogenated pyrroles, neonicotinoids, triazoles, and pyridine carboxamides.

Acylalanines include, for example, metalaxyl, metalaxyl-M (mefenoxam), furalaxyl, benalaxyl, benalaxyl-M (kiralaxyl), and the like, especially metalaxyl. Oxyacetamides include, for example, flufenacet and mefenacet. Triazinones include, for example, metribuzin, hexazinone, and metamitron, especially metribuzin. Sulfonylureas include, for example, metsulfuron-methyl, nicosulfuron, amidosulfuron, bensulfuron methyl, chlorimuron ethyl, chlorsulfuron, cinosulfuron, primisulfuron, pyrazosulfuron ethyl, thifensulfuron methyl, triasulfuron, and tribenuron methyl, especially metsulfuron-methyl or nicosulfuron. Strobilurins include, for example, trifloxystrobin, azoxystrobin, fluoxastrobin, dimoxystrobin, and the like. Halogenated pyrroles include, for example, chlorfenapyr. Neonicotinoids include, for example, imidacloprid, acetamiprid, clothianidin, dinotefuran, thiamethoxam, and the like. Triazoles include, for example, cyproconazole, prothioconazole, tebuconazole, metconazole, and the like. Pyridine carboxamides include, for example, diflufenican, picolinafen, and the like.

The agricultural compositions can include other components such as water, organic solvents, biocides, surfactants, wetting agents, antifoam agents, pH-adjusting agents, or combinations thereof.

In some aspects, the agricultural composition includes an organic solvent comprising an aromatic hydrocarbon. In some aspects, the aromatic hydrocarbon solvent has a flash point greater than 80° C.

In some aspects, the agricultural composition is prepared in the form of an emulsion, suspension, concentrate, or suspoemulsion.

The invention includes a method of making an agricultural composition. The method comprises combining an agricultural active selected from acylalanines, oxyacetamides, triazinones, and sulfonylureas with an inhibitor composition as described above. The inhibitor composition is used in amount effective to inhibit crystal growth of the agricultural active as determined by optical microscopy or dynamic light scattering.

### Crystal Growth Inhibition

When the inhibitor compositions described above are combined with 0.1 to 5 wt. % of an agricultural active, especially an agricultural active selected from acylalanines, oxyacetamides, triazinones, and sulfonylureas, the compositions can inhibit crystal growth of the agricultural active.

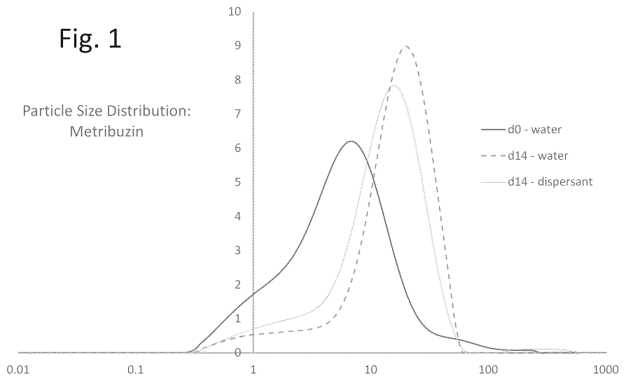

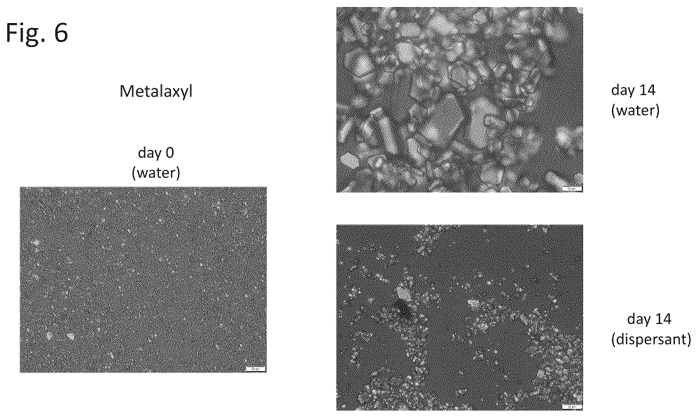

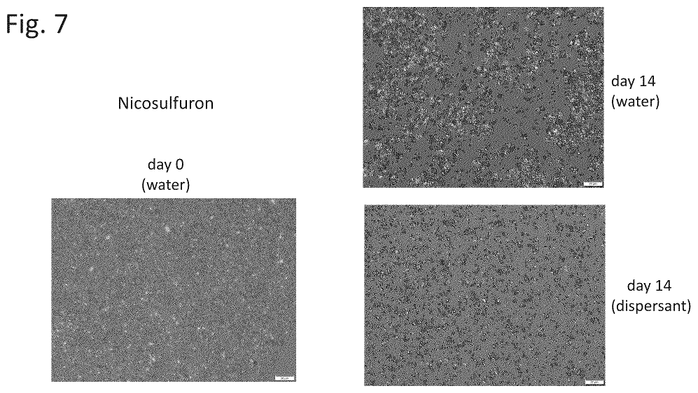

A convenient way to evaluate crystal growth (an inhibition of growth) is to measure how the average particle size of the agricultural active changes over two weeks at elevated temperature when dissolved, dispersed, or suspended in water with and without an added inhibitor composition. The evaluation of crystal growth can be performed by visual inspection of optical micrographs (see FIGS. 6 and 7) or by measuring average particle size by dynamic light scattering, laser diffraction, or other suitable techniques. Measurement generates a curve showing a distribution of the relative amounts of particles having a particular average particle diameter (typically in μm). One suitable dynamic light scattering (DLS) method is described below. FIGS. 1-5 and Tables 2-4 below show representative results of such DLS measurements.

The following examples merely illustrate the inventive subject matter. Many similar variations within the scope of the claims will immediately be apparent to those skilled in the art.

### Example 1

### Preparation of an Inhibitor Composition

A round-bottom flask equipped with an agitator, condenser, and nitrogen sparge tube is charged with monomethyl-terminated polyethylene glycol (“mPEG750,” 406 g), propylene glycol (591 g), styrene (418 g, 35 wt. % based on charged monomers), methacrylic acid (60 g), monomethyl-terminated polyethylene glycol methacrylate (“macromonomer,” 50 wt. % in water, 1379 g) and dodecanethiol (17 g). Separately, a solution of 2,2-azobis(2-methylpropionamide)dihydrochloride (17 g in 116 g of water) is prepared. The flask contents are heated to 70° C., and the initiator solution is then added via peristaltic pump over 3 h. On completion of the addition, the reaction mixture is held at 70° C. for 1 h. The resulting acidic solution is cooled and diluted with water (about 1500 g). The product is a mixture of an acidic comb copolymer of M_{w} about 30 kDa (by gel permeation chromatography) in mPEG750 solvent, water, and propylene glycol. The comb copolymer has recurring units of styrene, methacrylic acid, and the macromonomer. The weight ratio of comb copolymer to mPEG750 is about 3:1.

When a similar experiment is performed using glycerol instead of propylene glycol, the comb copolymer has a weight-average molecular weight of about 60 kDa, demonstrating that choice of organic solvent (or solvent combination) can be used to influence the molecular weight of the comb copolymer.

Design Aspects: Results with Metalaxyl

The procedure of Example 1 is generally followed to make inhibitor compositions with a different macromonomer (mPEG2000 methacrylate), different amounts of styrene (30 or 40 wt. %), different hydrophobic monomers (α-methylstyrene, benzyl methacrylate, or 2-ethylhexyl acrylate), dispersants of various molecular weights (from 6 kDa to 110 kDa), different alkyl-capped polyalkoxylate solvents (mPEG350, mPEG2000), different amounts of mPEG750 (4 to 14 wt. %), and different acidities (acidic or neutral pH). These inhibitor compositions are tested with metalaxyl in 14-day stability tests at 54° C. The particle size distributions and polydispersities are determined by dynamic light scattering as described below, and the results appear in Table 2.

As shown in Table 2, for metalaxyl, the length of the alkyl-capped polyalkoxylate chain in the methacrylate macromonomer can be varied significantly without adversely impacting crystal growth inhibition. The styrene content can be varied, but other tested hydrophobic monomers are not as effective in inhibiting crystal growth with metalaxyl, and some result in unacceptable sedimentation; the positive results with styrene might be due to better stacking of the aromatic ring of metalaxyl with styrenic residues. Dispersant molecular weight appears optimal within about 10 kDa to 50 kDa for metalaxyl. Other results indicate that the alkyl-capped polyalkoxylate solvent molecular weight and proportion can be successfully varied. Neutralization of acidic groups in the inhibitor composition is unhelpful for inhibiting crystal growth for metalaxyl; in contrast, the (unneutralized) acidic version demonstrates significantly reduced crystal growth.

### GPC Characterization

The molecular weight of the comb copolymer dispersant is approximated using gel permeation chromatography (GPC). A calibration curve is generated using polystyrenes having narrow molecular weight distributions and molecular weights ranging from 500 to 350,000 Da. The isocratic method uses THE as the only mobile phase. A size-exclusion column (TSKGel G4000HHR, 7.8×300 mm, 5 μm) and a refractive index (RI) detector (eventually coupled with variable-wavelength ultraviolet (UV) detector) are used to measure weight-average molecular weight (M_{w}) and molecular weight distribution (M_{w}/Mₙ). Samples (1 wt. % in THF) are injected at 1 mL/minute for a 14-minute program.

### Suspension Concentrates

Aqueous suspension concentrates (“SC”) are formulated as follows. A first mixture (“Phase A,” 90 wt. % of the SC formulation) is produced by combining the agricultural active, comb copolymer dispersant, STEP-FLOW® 26F (nonionic surfactant, Stepan Company), PROXEL™ GXL biocide (Lonza), SAG™ 1572 antifoam emulsion (Momentive), and water. Separately, a second mixture (“Phase B,” 10 wt. %) is prepared by combining glycerol, xanthan gum, and water. Phase A is combined with zirconium beads (diameter: 1.25/1.60 mm; density: 2.6) and is milled for 8 min. until homogeneous. When metsulfuron is the active, sodium bicarbonate buffer is included to adjust pH of Phase B to 6.6. Phase B is then combined and mixed at high shear (2000 rpm) with Phase A to give the completed formulation. Details of typical formulations appear in Table 1.

### Stability Testing

Formulation stability is evaluated by visual inspection of samples stored in an oven at 54° C. for 14 days. Any creaming or sedimentation that occurs is noted. Stability tests are also performed under freeze-thaw conditions (4 days at 54° C., then 1 night at −10° C. for 2 cycles) and at 40° C. for 28 days, with good stability noted by visual inspection.

### Particle Size Measurement by Dynamic Light Scattering

The d(0.1), d(0.5), and d(0.9) values are determined using dynamic light scattering with a Malvern MASTERSIZER™ 2000 particle-size analyzer with Hydro MU attachments. Saturated aqueous NaCl (300 g/L) is used for metalaxyl; tap water or deionized water is used for other agricultural actives. The values reported in Table 2 under the headings “d(0.1),” “d(0.5),” and “d(0.9)” refer, respectively, to the average particle size (in μm) that 10%, 50%, or 90% of the particles are at or below. D[4,3], a measure of polydispersity, is also reported.

### Optical Microscopy Evaluation

Crystalline morphology is assessed by optical microscopy using an Olympus BX5 microscope. Samples are observed as is (no dilution) as thin layers; in some cases, samples are diluted with water or glycerol. Images (three per sample) are taken at 400× magnification and processed using Olympus Stream image analysis software.

TABLE 1
Suspension Concentrate Formulations

| | Components (wt. %) | | | | |
|---|---|---|---|---|---|
| Agricultural active | Flufenacet | Metalaxyl | Nicosulfuron | Metribuzin | Metsulfuron |
| Phase A (90 wt. %) | | | | | |
| amount of active (wt. %) | 44.1 | 19.5 | 19.5 | 40.2 | 19.5 |
| comb copolymer dispersant | 4.5 | 2.0 | 2.0 | 3.8 | 2.0 |
| STEP-FLOW ® 26F nonionic surfactant | 1.6 | 1.5 | 1.5 | 1.4 | 1.5 |
| PROXEL ™ GXL biocide | 0.2 | 0.2 | 0.2 | 0.2 | 0.2 |
| SAG ™ 1572 antifoam emulsion | 0.1 | 0.2 | 0.2 | 0.2 | 0.2 |
| glycerol | 0 | 20 | 20 | 9.6 | 20 |
| water | 39.6 | 46.6 | 46.6 | 34.6 | 46.6 |
| sodium bicarbonate | 0 | 0 | 0 | 0 | 0.4 |
| Phase B (10 wt. %) | | | | | |
| glycerol | 4.3 | 4.3 | 4.3 | 4.3 | 4.3 |
| xanthan gum | 0.2 | 0.2 | 0.2 | 0.2 | 0.2 |
| water | 5.5 | 5.5 | 5.5 | 5.5 | 5.5 |

Results with Various Agricultural Actives

Table 3 summarizes the impact of dispersant on crystal growth inhibition with various agricultural actives, including metalaxyl, metribuzin, metsulfuron, and nicosulfuron.

Immediately after samples are prepared, they are analyzed by optical microscopy and dynamic light scattering as described above. Samples containing only the agricultural active and water are analyzed at Day 0 and then again at Day 14 to evaluate crystal growth in the absence of the inventive inhibitor compositions. A sample containing the inhibitor composition, i.e., “dispersant,” is evaluated at Day 14, and the results are compared with the Day 0 and Day 14 results for no dispersant. The metalaxyl sample is also analyzed at Day 7.

In general, with each of the agricultural actives tested, including the inventive inhibitor composition effectively reduces crystal growth at Day 14. For some actives, such as metalaxyl or metsulfuron, the impact is dramatic; for others, such as metribuzin, the improvement is more subtle. Moreover, we found through testing that crystal growth problems (or lack thereof) can be source- or sample-dependent for the same agricultural active. For instance, others have reported flufenacet to have crystal-growth issues, but our tested baseline samples did not demonstrate significant problems. Additionally, metribuzin we obtained from different sources showed significant differences in the degree of crystal growth in baseline samples.

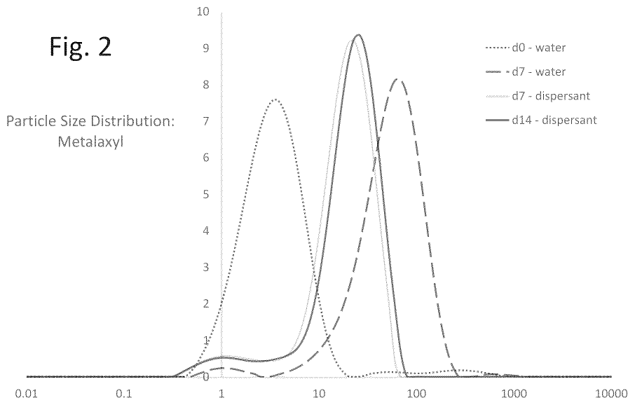

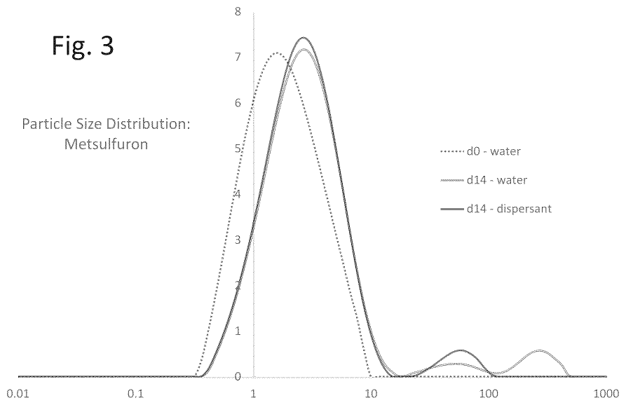

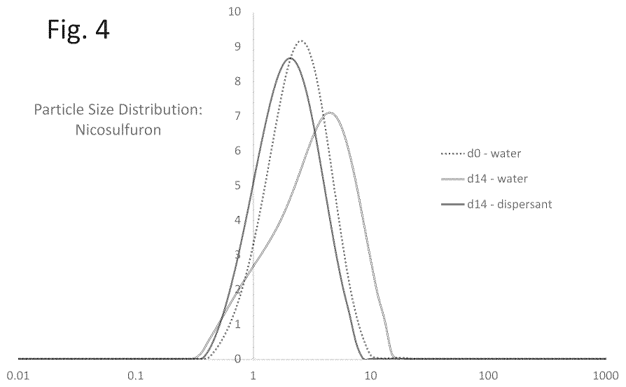

FIGS. 1-4 show the distributions of average particle sizes (in μm) for each agricultural active as measured using dynamic light scattering. In each case, the d14 curve for the aqueous agricultural active (no dispersant, 14 days) is displaced, as expected, to the right, reflecting crystal growth. When an inventive inhibitor composition is present, the d14 curve remains to the right of the do curve (no dispersant, 0 days), but left of the d14 water curve, demonstrating that crystal growth has been inhibited by the dispersant. The difference is readily apparent for metribuzin (FIG. 1) and nicosulfuron (FIG. 4), and it is dramatic for metalaxyl (FIG. 2). For metsulfuron (FIG. 3), the displacement of the curve with dispersant is subtle; however, the Day 14 sample with no dispersant has a substantial proportion of very large crystals (100-500 μm).

The values reported in Table 3 under the headings “d(0.1),” “d(0.5),” and “d(0.9)” refer, respectively, to the average particle size (in μm) that 10%, 50%, or 90% of the particles are at or below. For the untreated aqueous sample of metalaxyl at 14 days, for instance, 90% of the particles have an average particle size less than 120 μm. In contrast, when the dispersant is included, 90% of the particles have an average particle size less than 23 μm.

The % change from untreated to dispersant-treated samples in the d(0.5) and d(0.9) values is reported in Table 3 as the “d50% growth” or “d90% growth,” respectively. Thus, for metalaxyl, 1560% is the % change in d(0.5) from 3.2 μm at Day 0 to 53 μm at Day 14, and 57% is the % change in d(0.5) from 3.2 μm at Day 0 (untreated sample) to 5.0 μm at Day 14 for the sample containing dispersant.

The value of D[4,3] is a measure of the polydispersity (or breadth) of the particle size distribution, with higher numbers indicating a broader distribution of particle sizes in the sample.

### Optical Microscopy Results

Optical microscopy can also be used to evaluate crystal growth inhibition. FIG. 6 shows a series of images obtained at the same magnification for solutions of metalaxyl. The white bar at the bottom right represents 20 μm. The Day 0 image shows well-dispersed, small particles. Without the dispersant, crystal growth is dramatic by Day 14. However, when the inventive inhibitor composition is included, crystal growth by Day 14 is greatly reduced. The trend is similar in FIG. 7 for nicosulfuron. The white bar at the bottom right again represents 20 μm. The reduction with dispersant present is substantial, although the crystal growth after 14 days in water is less dramatic for nicosulfuron when compared with the same image for metalaxyl.

### Synergy Study

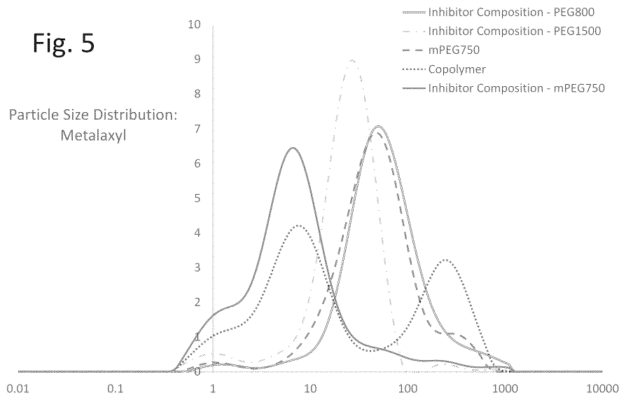

The combination of the comb copolymer dispersant and the mPEG solvent provides excellent results in inhibiting crystal growth. FIG. 5 and Table 4 summarize the results of a study performed with metalaxyl to clarify the benefits of having both components present in the inventive inhibitor compositions. When only the comb copolymer is present, the particle size distribution is decidedly bimodal, with a large fraction of the Day 14 product having an average particle size from 100-1000 μm. When only mPEG750 is present (i.e., without any comb copolymer dispersant), the distribution at Day 14 is more unimodal but peaks at values greater than 100 μm (d(0.9) of 140 μm). In contrast, when the comb copolymer is combined with mPEG750, the particle size distribution is unimodal and shifts to lower average particle size values of about 10 μm (d(0.9) of 26 μm). Combining the comb copolymer with PEG1500 (same hydroxyl number as mPEG750) or PEG800 (roughly the same molecular weight as mPEG750) is less effective than mPEG750 in shifting the particle size distribution curve to lower average particle sizes.

TABLE 2
Effect of Inhibitor Composition Design on
Crystal Growth Inhibition with Metalaxyl

| DLS parameter | d(0.1), μm | d(0.5), μm | d(0.9), μm | D[4, 3] |
|---|---|---|---|---|
| Macromonomer | | | | |
| mPEG 750 methacrylate | 1.2 | 5.3 | 13 | 9.1 |
| mPEG 2000 methacrylate | 1.4 | 6.4 | 19 | 17 |
| Hydrophobic monomer | | | | |
| styrene, 30 wt. % | 1.2 | 5.3 | 13 | 9.1 |
| styrene, 35 wt. % | 1.3 | 5.9 | 26 | 21 |
| styrene, 40 wt. % | 1.3 | 5.9 | 23 | 15 |
| benzyl methacrylate, 9 wt. %* | 24 | 60 | 200 | 100 |
| benzyl methacrylate, 15 wt. %* | 25 | 63 | 160 | 87 |
| α-methylstyrene* | sedimentation | | | |
| 2-ethylhexyl acrylate* | sedimentation | | | |
| Dispersant mol. wt. (Mw) | | | | |
| 6 kDa* | 26 | 67 | 150 | 84 |
| 20 kDa | 6.2 | 21 | 41 | 22 |
| 33 kDa | 6.1 | 18 | 36 | 20 |
| 110 kDa* | 11 | 34 | 98 | 67 |
| Solvent | | | | |
| mPEG 750, 4 wt. % | 5.4 | 32 | 13 | 1.4 |
| mPEG 750, 9 wt. % | 5.0 | 23 | 11 | 1.4 |
| mPEG 750, 14 wt. % | 4.7 | 38 | 14 | 1.3 |
| mPEG 350, 9 wt. % | 5.4 | 34 | 13 | 1.4 |
| mPEG 2000, 9 wt. % | 4.7 | 31 | 12 | 1.3 |
| pH, acidic | 1.1 | 4.6 | 12 | 8.0 |
| pH, neutral* | 4.9 | 15 | 38 | 19 |

*Comparative examples

TABLE 3
Impact of Dispersant on Crystal Growth Inhibition with
Selected Agricultural Actives

| | | | | | d50% | d90% | |
|---|---|---|---|---|---|---|---|
| Sample | Day | d(0.1) | d(0.5) | d(0.9) | growth | growth | D[4, 3] |
| Metalaxyl | 0 | 1.2 | 3.2 | 7.8 | — | — | 9.7 |
| untreated | 14 | 18 | 53 | 120 | 1600 | 1400 | 62 |
| (water) | | | | | | | |
| w/dispersant | 14 | 1.4 | 5.0 | 23 | 56 | 190 | 11 |
| Metribuzin | 0 | 1.1 | 5.2 | 16 | — | — | 8.5 |
| untreated | 14 | 4.3 | 16 | 32 | 210 | 100 | 18 |
| (water) | | | | | | | |
| w/dispersant | 14 | 2.6 | 12 | 28 | 130 | 75 | 17 |
| Metsulfuron | 0 | 0.65 | 1.6 | 4.3 | — | — | 2.1 |
| untreated | 14 | 0.96 | 2.5 | 7.3 | 56 | 70 | 13 |
| (water) | | | | | | | |
| w/dispersant | 14 | 0.94 | 2.4 | 6.3 | 50 | 47 | 4.7 |
| Nicosulfuron | 0 | 1.0 | 2.3 | 4.6 | — | — | 2.6 |
| untreated | 14 | 0.90 | 3.2 | 7.6 | 39 | 65 | 3.8 |
| (water) | | | | | | | |
| w/dispersant | 14 | 0.82 | 1.8 | 3.9 | −22 | −15 | 2.2 |

Particle size (μm) and size distribution by dynamic light scattering. Day 0 values use the agricultural active in water. The d50 and d90% growth values are compared with the Day 0 values. D[4, 3] is a measure of sample polydispersity.

TABLE 4
Synergy study with Metalaxyl. Day 14 results (see FIG. 5)

| DLS parameter | d(0.1), μm | d(0.5), μm | d(0.9), μm | D[4, 3] |
|---|---|---|---|---|
| Comb copolymer + | 1.3 | 5.9 | 26 | 21 |
| mPEG750 | | | | |
| Comb copolymer only* | 1.9 | 11 | 300** | 91 |
| mPEG750 only* | 13 | 43 | 140 | 69 |
| Comb copolymer + | 7.6 | 23 | 47 | 30 |
| PEG1500* | | | | |
| Comb copolymer + | 18 | 50 | 170 | 85 |
| PEG800* | | | | |

*Comparative examples
**Bimodal distribution

The preceding examples are meant only as illustrations; the following claims define the scope of the invention.

We claim:

1. An inhibitor composition comprising:
(a1) 60 to 97 wt. % of a comb copolymer dispersant comprising recurring units of styrene, methacrylic acid, and a methacrylate ester of a first alkyl-capped polyalkoxylate, the first alkyl-capped polyalkoxylate having a number average molecular weight within the range of 300 to 3,000 Da; and
(b1) 3 to 40 wt. % of a second alkyl-capped polyalkoxylate having a number average molecular weight within the range of 300 to 3,000 Da; wherein the weight percent amounts are based on the combined amounts of (a1) and (b1);
wherein the composition, when combined at 0.1 to 5 wt. % with an agricultural active, can inhibit crystal growth of the agricultural active.

2. The composition of claim 1 wherein the comb copolymer dispersant has a number average molecular weight within the range of 10 to 150 kDa.

3. The composition of claim 1 wherein the first alkyl-capped polyalkoxylate has a number average molecular weight within the range of 350 to 2,000 Da.

4. The composition of claim 1 wherein the second alkyl-capped polyalkoxylate has a number average molecular weight within the range of 350 to 2,000 Da.

5. The composition of claim 1 wherein at least one of the first and second alkyl-capped polyalkoxylates is a monomethyl-terminated polyethylene glycol (mPEG).

6. The composition of claim 1 wherein the dispersant comprises 25 to 50 wt. % of styrene recurring units based on the amount of dispersant.

7. The composition of claim 1 wherein residual acidic groups of the dispersant are unneutralized.

8. An agricultural composition comprising:
(a2) an agricultural active selected from the group consisting of acylalanines, oxyacetamides, triazinones, sulfonylureas, strobilurins, halogenated pyrroles, neonicotinoids, triazoles, and pyridine carboxamides;
(b2) 0.1 to 5 wt. %, based on the amount of agricultural active, of the inhibitor composition of claim 1.

9. The composition of claim 8 wherein the agricultural active is an acylalanine, an oxyacetamide, a triazinone, or a sulfonylurea.

10. The composition of claim 8 wherein the agricultural active is metalaxyl.

11. The composition of claim 8 wherein the agricultural active is metsulfuron-methyl or nicosulfuron.

12. The composition of claim 8 wherein the agricultural active is metribuzin.

13. The composition of claim 8 further comprising one or more components selected from the group consisting of water, organic solvents, biocides, surfactants, wetting agents, pH-adjusting agents, and antifoam agents.

14. The composition of claim 8 comprising 0.2 to 3 wt. % of the inhibitor composition based on the combined amounts of (a2) and (b2).

15. The composition of claim 8 wherein the organic solvent comprises an aromatic hydrocarbon having a flash point greater than 80° C.

16. The composition of claim 8 wherein the agricultural active is metalaxyl, and after storage for 14 days at 54° C., at least 90 wt. % of the particles have an average diameter less than 50 μm as measured by dynamic light scattering.

17. The composition of claim 8 in the form of an emulsion, suspension concentrate, or suspoemulsion.

18. A method which comprises combining an agricultural active selected from the group consisting of acylalanines, oxyacetamides, triazinones, sulfonylureas, strobilurins, halogenated pyrroles, neonicotinoids, triazoles, and pyridine carboxamides with an inhibitor composition, wherein the inhibitor composition comprises:
(a1) 60 to 97 wt. % of a comb copolymer dispersant comprising recurring units of styrene, methacrylic acid, and a methacrylate ester of a first alkyl-capped polyalkoxylate, the first alkyl-capped polyalkoxylate having a number average molecular weight within the range of 300 to 3,000 Da; and
(b1) 3 to 40 wt. % of a second alkyl-capped polyalkoxylate having a number average molecular weight within the range of 300 to 3,000 Da; wherein the weight percent amounts are based on the combined amounts of (a1) and (b1); and
wherein the inhibitor composition is present in an amount effective to inhibit crystal growth of the agricultural active as determined by optical microscopy or dynamic light scattering.

19. The method of claim 18 wherein the amount of inhibitor composition used is 0.1 to 5 wt. % based on the combined amounts of agricultural active and inhibitor composition.

20. The method of claim 18 wherein the agricultural active is an acylalanine, an oxyacetamide, a triazinone, or a sulfonylurea.
